(19) United States
(12) Patent Application Publication
(10) Pub. No.: US 2018/0200970 A1
(43) Pub. Date: Jul. 19, 2018

(54) Method and Apparatus for Encapsulating Tubing with Material Having Engineered Weakened Portions

(71) Applicant: MID-SOUTH CONTROL LINE, LLC, Harvey, LA (US)

(72) Inventors: Clifford Westley Westwood, Conroe, TX (US); Richard Joseph Baudier, Spring, TX (US); Blaise John Cobert, Spring, TX (US)

(21) Appl. No.: 15/872,326

(22) Filed: Jan. 16, 2018

Related U.S. Application Data
(60) Provisional application No. 62/446,987, filed on Jan. 17, 2017.

(51) Int. Cl. B29C 70/86; B29C 43/18; B32B 1/08

(52) U.S. Cl. CPC B29C 70/865; B29C 43/18; B29C 2049/2004; B29C 2043/182; B32B 1/08

(57) ABSTRACT

An elongate central member (including, without limitation, a conduit, cable or wire) has an outer coating or jacket constructed of polymer(s), thermoplastic resin(s) or other protective material. The outer coating or jacket can include at least one engineered area of reduced material, which can be created through the extrusion process or through removal of extruded material in a secondary process, thereby forming at least one intentionally weakened section of the coating or jacket. When desired, the outer coating or jacket can be partially or totally removed without damage to the encased elongate central member.

### CROSS REFERENCES TO RELATED APPLICATION

Priority of U.S. provisional patent application Ser. No. 62/446,987, filed Jan. 17, 2017, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

### 1. Field of the Invention

The present invention pertains to encapsulated conduits utilized in a variety of applications including, without limitation, in the oil and gas industry. More particularly, the present invention pertains to metallic conduits encapsulated within polymer material having engineered weak points in said polymer encapsulation material (such as, for example, predetermined areas having reduced encapsulation material). More particularly still, the present invention pertains to polymer-encapsulated metallic conduits that permit stripping and/or removal of said polymer encapsulation material from an encased conduit, typically without requiring specialized tools, knives or blades.

### 2. Brief Description of the Prior Art

Elongated cables and tubular conduits are used in many different industries including, without limitation, in the oil and gas industry. Such elongated cables and tubular conduits are frequently installed in wells that penetrate subterranean formations in order to produce unrefined oil, gas and/or other hydrocarbons. Such elongated cables or conduits may be used to for a variety of purposes, such as the conveyance of electrical currents or fluids. For example, said elongated conduits can be used to actuate hydraulically-operated tools installed downhole within a wellbore.

Frequently, such conduits comprise a metallic tube that is used to contain or convey fluids or other objects over a desired distance. Said conduits are commonly encapsulated within an extruded thermoplastic coating used to protect and/or insulate the metallic tube, including the exterior surface of said tube. In many cases, such encapsulation material is also utilized to combine multiple conduits in a single bundle—commonly referred to as a “flat-pack” or “flatpack”.—to make the installation of such product easier and more efficient. Said flatpacks can comprise metallic tubes, metallically armored cables and/or elongate mechanical components such as solid or stranded metallic rods and cables, or various combinations thereof. Further, said flatpacks can include components having numerous different diameters and materials.

During installation of these elongate conduits, it is frequently desirable to remove the encapsulation layer or coating at various points along the length of the product in order to gain access to the encapsulated tube. Conventional methods of removing this material include using a sharp knife or other specially designed tool or apparatus to cut or abrade through the coating to reach the encapsulated tube. In some cases, a heat source is also used to soften the encapsulation/coating materials. Although functional, such existing methods incorporating the use of uncommon, specially designed tools or, blades, and/or heat to cut/strip encapsulation materials introduce significant risk of damaging the encapsulated tubing, thus adversely affecting integrity and introducing imperfections in the sealing surface area of both hydraulic and electrical connectors. The integrity of the sealing surfaces is critical to the performance of the product.

A method of using a “pull cord” molded within said encapsulation material exists—however, such method still generally requires a user to utilize a blade of some sort to peel back a layer of encapsulation to expose the “pull cord”, which would allow the user to wrap the tear cord and pull, thereby forming a “slit” in the encapsulation (and providing access to the underlying tubing) to a desired length. The process of peeling back the encapsulation is inherently unsafe, and much force is needed for a user to pull the cord to enable the user to carry out the task of stripping encapsulation material from the tubing.

Further, such conventional methods and tools can be hazardous, as workers can easily cut themselves with sharp knives and/or other tools, while heat sources may be dangerous to use in environments where flammable materials, such as fossil fuels, are present. In addition, many of these conventional tools tend to damage the exterior surface of an encapsulated metallic tube, and damage can also occur to areas of encapsulation material where removal was not necessary or desired.

Thus, there is a need for a method and apparatus for encapsulating conduits, cables and/or other elongate members with an outer polymer material or other protective jacket. Said protective outer jacket should be capable of being quickly and efficiently removed from all or part of said conduit, cable and/or other elongate member without the use of a knife or other tool, and without damaging or gouging said conduit, cable and/or other elongate member.

### SUMMARY OF THE INVENTION

In a preferred embodiment, the present invention comprises at least one elongate central member (including, without limitation, a conduit, cable or wire) having a protective outer coating or jacket. Said outer coating or jacket can comprise a polymer, or thermoplastic resin, and can beneficially include at least one engineered weak point(s) having reduced material. Said engineered weak points can be created through the extrusion process or created through removal of extruded material in a secondary process. Said protective outer jacket should be capable of being quickly and efficiently removed from all or part of said conduit(s), cable(s) and/or other elongate encapsulated member(s) without the use of a knife or other tool, and without damaging or gouging said conduit, cable and/or other elongate member.

By way of illustration, but not limitation, said elongate central member can comprise a tubular conduit capable of being deployed on a spool or reel. A protective outer coating or jacket is generally disposed around the outer or external surface of said tubular conduit. Although materials of construction may vary for different applications and/or operational environments, in a preferred embodiment said tubular conduit can comprise a metallic material. The dimensions of said tubular conduit may also vary for different applications and/or operational environments.

Said tubular conduit can comprise a “control line” used to convey fluids from a surface location to one or more downhole locations within a wellbore extending into subterranean formations. Alternatively, said tubular conduit may contain or convey hydraulic fluid as part of a closed loop hydraulic system utilized to actuate various hydraulic tools or equipment situated within a wellbore, at least one insulated conductor used for transmission of electrical power and/or at least one fiber optic cable for transmission of electronic data.

Said tubular conduit is beneficially encapsulated within a protective outer jacket. In a preferred embodiment, said protective outer jacket comprises a layer of extruded thermoplastic polymer or other inert material that serves to surround, protect and insulate tubular conduit, as well as any contents. Notwithstanding the foregoing, said protective jacket can also be constructed of any number of different materials embodying desired characteristics without departing from the scope of the present invention.

In a preferred embodiment, said protective outer jacket beneficially includes at least one engineered weakened section(s); that is, at least one strategically positioned region comprising reduced material mass. Said at least one engineered weakened section(s) can be created through an extrusion process, or through removal of extruded material in a secondary process. As a result, said jacket material is at its weakest in said section(s) of reduced material, and lacks the strength of other surrounding portions of said protective jacket.

A user can easily pinch or grip a portion of said jacket material and pull or tug said material in a direction away from the encapsulated tubular conduit. Because the tear strength of said protective jacket is lowest near area(s) of reduced material—where said protective jacket is at its thinnest—said protective jacket preferentially tears away from an encapsulated tubular conduit at or in the vicinity of said area(s) of reduced material when sufficient force is applied.

In this manner, some or all of said protective jacket can be separated from the encapsulated tubular conduit, thereby exposing the outer surface of said tubular conduit. As such, said protective jacket material can be removed from said encapsulated tubular conduit without requiring use of a knife or other cutting or specially designed stripping tool, thereby ensuring that the outer surfaces of said tubular conduit remain free from nicks, gouges or abrasions during the process of said jacket removal.

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a perspective view of an encapsulated conduit assembly of the present invention, generally comprising an elongate tubular conduit and a protective outer coating having engineered region(s) of reduced material.

FIG. 2 depicts a perspective view of an encapsulated conduit assembly of the present invention, wherein a portion of said protective outer coating is partially removed from said conduit.

FIG. 3 depicts an end view of an encapsulated conduit assembly of the present invention.

FIG. 4 depicts a top view of an encapsulated conduit assembly of the present invention.

FIG. 5 depicts a bottom view of an encapsulated conduit assembly of the present invention.

FIG. 6 depicts a perspective view of an alternative embodiment encapsulated conduit assembly of the present invention.

FIG. 7 depicts an end view of said alternative embodiment encapsulated conduit assembly of the present invention.

### DETAILED DESCRIPTION OF A PREFERRED EMBODIMENT

In a preferred embodiment, an encapsulated conduit assembly of the present invention comprises an elongate central member (including, without limitation, a conduit, cable or wire) having a protective outer coating or jacket. Said outer coating or jacket can comprise a polymer, thermoplastic resin and/or combination thereof, and can beneficially include at least one engineered weak point(s)—that is, at least one strategically positioned region comprising reduced jacket material. Said at least one engineered weak point(s) can be created through an extrusion process, or created through removal of extruded material in a secondary process.

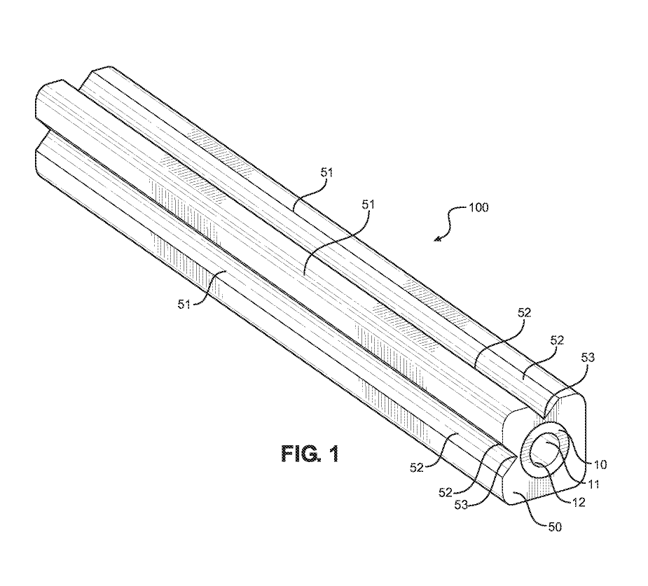

Referring to the drawings, FIG. 1 depicts a perspective view of an encapsulated conduit assembly 100 of the present invention. Said encapsulated conduit assembly 100 comprises central elongate tubular conduit 10 having central through bore 11 defining inner surface 12. Protective outer coating or jacket 50 is generally disposed around the outer or external surface of said tubular conduit 10. Although materials of construction may vary for different applications and/or operational environments, in a preferred embodiment said tubular conduit 10 can comprise a steel alloy; said steel alloy can include, but is not necessarily limited to, stainless steel(s), corrosion resistant alloy(s), duplex stainless steel alloy(s), and carbon or galvanized carbon steel(s).

Likewise, the dimensions of tubular conduit 10 may also vary for different applications and/or operational environments. In a preferred embodiment, the outer diameter of said tubular conduit 10 may vary from one-eighth (⅛) inch or less, to greater than 1 inch. Similarly, the inner diameter of central through bore 11, as well as wall thickness of said tubular conduit 10, can also vary to accommodate different applications and/or operational environments. In a preferred embodiment, said wall thickness can typically fall within a range between 0.016 inch (or smaller) to 0.083 inch or larger.

Tubular conduit 10 may be used to convey fluids from a surface location to one or more downhole locations within a wellbore that extends into subterranean formations. Frequently, such chemicals can comprise specialized chemical products designed to reduce hydrates, asphaltenes, and/or other compounds that may be present in fluids produced from an oil or gas well. Further, said tubular conduit 10 can also convey other chemicals to various locations downhole within a wellbore such as, for example, low dosage hydrate inhibitors, methanol ethylene glycol, ethanol and/or propanol. Said tubular conduit 10 may be used to contain or convey hydraulic fluid as part of a closed loop hydraulic system utilized to actuate various hydraulic tools or equipment situated within a wellbore.

Alternatively, tubular conduit 10 can contain at least one insulated conductor used for transmission of electrical power and/or electronic data in connection with sensors and/or electrical tools disposed within a wellbore. Said tubular conduit 10 can also contain at least one fiber optic cable for transmission of electronic data including, without limitation, in connection with distributed temperature, seismic, or acoustic sensor(s) disposed within a wellbore. Fluid contained within central bore 11 of tubular conduit 10 can be maintained at a higher or lower fluid pressure (vacuum) than the surrounding environment of said tubular conduit 10.

Still referring to FIG. 1, tubular conduit 10 is encapsulated within protective outer jacket 50. In a preferred embodiment, said protective outer jacket 50 comprises a layer of extruded thermoplastic polymer or other inert material. Said protective outer jacket 50 serves to surround, protect and insulate tubular conduit 10, as well as any contents within central through bore 11, from harmful thermal effects and corrosive materials present within a surrounding environment, such as within a subterranean well bore.

In addition to other benefits, jacket 50 also protects tubular conduit 10 from inadvertent physical contact, abrasion or damage such as, for example, during installation and/or retrieval of said insulated conduit assembly 100 in a wellbore. Although applications may vary without departing from the scope of the present invention, insulated conduit assembly 100 may be placed within an annular space between an inner surface of a well casing and an outer surface of a production tubing, as well as outside said well casing. In a preferred embodiment, insulated conduit assembly 100 can be wound on a spool or reel for easy transportation, storage and/or deployment.

In a preferred embodiment, the inner and outer surfaces of tubular conduit 10 are smooth and continuous. The sealing surface of said tubular conduit 10 can be of major importance—thus, the exterior surface of said tubular conduit 10 should beneficially be free from nicks and gouges. Such nicks, gouges and/or other damage can result from use of a knife or other sharp edge instrument to cut away protective jacket 50 to remove said jacket from tubular conduit 10 or gain access to a pull cord. In addition, this work is frequently performed on a drilling rig where stringent safety rules and regulations make use of a knife or other open blade tools problematic.

It is to be observed that protective jacket 50 can be constructed of any number of different materials without departing from the scope of the present invention. By way of illustration, but not limitation, said protective jacket 50 can be polyamide, polyethylene, polypropylene, ethylene chlorotrifluoroerthlyene (ECTFE), Ethylene tetrafluoroethylene (ETFE), engineering thermoplastic vulcanates (ETPV) or a thermoplastic elastomer cross linking ethylene propylene diene monomer rubber and polypropylene (TPV/TPE/TPR). Said protective jacket 50 may also comprise perfluoroalkoxy (PFA), polyvinylidene fluoride (PVDF) or fluorinated ethylene propylene (FEP), Polyetheretherketone (PEEK), or material embodying similar beneficial characteristics.

In a preferred embodiment, outer jacket 50 beneficially includes at least one engineered weakened section(s); that is, at least one strategically positioned region comprising reduced material mass. Said at least one engineered weakened section(s) can be created through an extrusion process, or through removal of extruded material in a secondary process.

Still referring to FIG. 1, said outer jacket 50 comprises elongate grooves or channels 51. In a preferred embodiment, said elongate grooves or channels 51 are oriented substantially parallel to the longitudinal axis of said tubular conduit 10 and extend substantially along all or part of the length of encapsulated conduit assembly 100. Further, although the specific shape or configuration of said elongate channels 51 can vary without departing from the scope of the present invention, said elongate channels 51 are substantially V-shaped, being formed by converging sloped faces 52 defining channel bases 53. Said elongate channels cooperate to define elongate protrusion 54 there between; said elongate protrusion 54 is generally oriented parallel to the longitudinal axis of tubular conduit 10.

In a preferred embodiment, said channel bases 53 beneficially do not extend fully to the outer surface of tubular conduit 10 (that is, at least some portion of jacket material is disposed between said channel bases 53 and said outer surface of tubular conduit 10). The thickness of aid jacket material can be in the range between 0.005″ and 0.040″ inches between channel base 53 and outer surface of tubular conduit 10. As a result, said jacket material is at its weakest point between said channel bases 53 and outer surface of tubular conduit 10, and lacks the strength of other surrounding portions of protective jacket 50. Put another way, the tear strength of protective jacket 50 is lowest near channel bases 53 where said protective jacket 50 is at its thinnest.

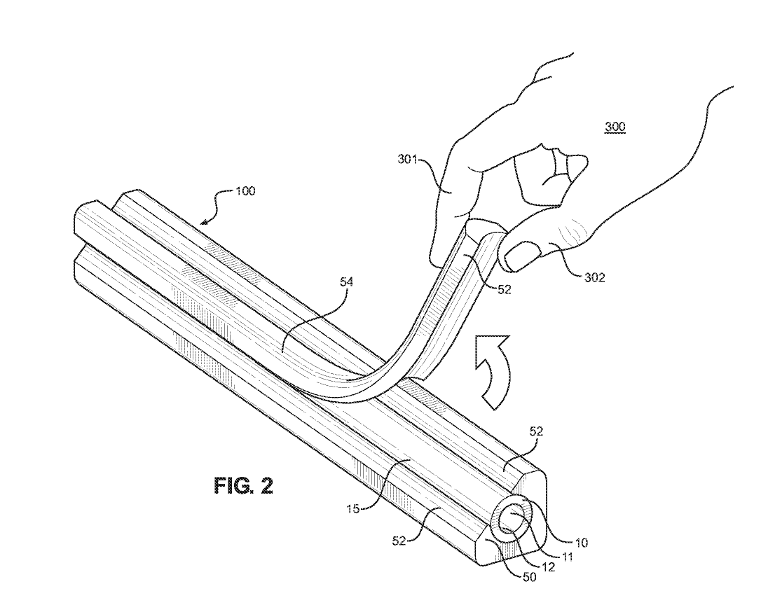

FIG. 2 depicts a perspective view of encapsulated conduit assembly 100 of the present invention, wherein a portion of said protective outer jacket 50 is partially removed from tubular conduit 10. As depicted in FIG. 2, a user can easily pinch or grip a portion of protrusion 54 with a common pair of plyers or a hand 300 (such as, for example, with index finger 301 and thumb 302) and pull said protrusion 54 in a direction away from tubular conduit 10. Because the tear strength of protective jacket 50 is lowest near channel bases 53 (where said protective jacket 50 is at its thinnest), said protective jacket 50 preferentially tears away from tubular conduit 50 at or in the vicinity channel bases 53 when sufficient force is applied.

In this manner, protrusion 54 can be separated from the remainder of protective jacket 50, thereby breaking the integrity of protective jacket 50 and exposing outer surface 15 of tubular conduit 10. After said protrusion 54 is at least partially removed from said tubular conduit 10, the remainder of said protective jacket 50 can be removed from—that is, slipped off of—said tubular conduit 10. In this manner, said protective jacket 50 can be removed from said tubular conduit 10 without requiring use of a knife or other cutting or specially designed stripping tool, thereby ensuring that outer surface 15 of tubular conduit 10 is not nicked or gouged during the process of said jacket removal.

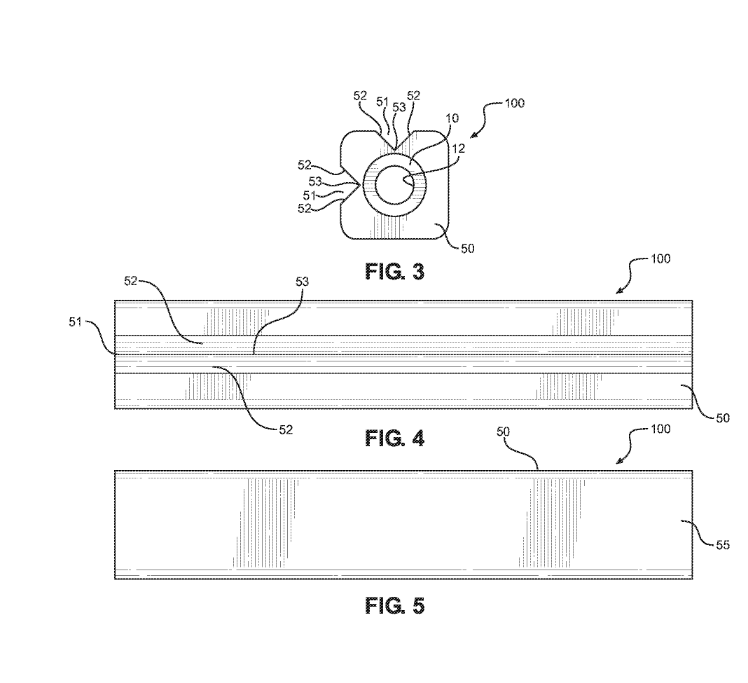

FIG. 3 depicts an end view of an encapsulated conduit assembly of the present invention. Encapsulated conduit assembly 100 comprises central elongate tubular conduit 10 having central through bore 11 defining inner surface 12. Protective outer jacket 50 is generally disposed around outer or external surface 15 of tubular conduit 10. In a preferred embodiment, outer jacket 50 beneficially includes at least one engineered weakened section(s) formed by at least one strategically positioned region comprising reduced material.

Still referring to FIG. 3, said outer jacket 50 further has elongate grooves or channels 51 oriented substantially parallel to the longitudinal axis of said tubular conduit 10 and extending substantially along all or part of the length of encapsulated conduit assembly 100. As depicted in FIG. 3, said elongate channels 51 are substantially V-shaped. Said elongate channels 51 are formed by converging sloped faces 52 defining channel bases 53, and cooperate to define elongate protrusion 54 between said elongate channels 51. Elongate protrusion 54 is generally oriented parallel to the longitudinal axis of tubular conduit 10.

FIG. 4 depicts a top view of an encapsulated conduit assembly 100 of the present invention, while FIG. 5 depicts a bottom view of an encapsulated conduit assembly 100 of the present invention. Referring to FIG. 4, an elongate channel 51 extends substantially along all or part of the length of outer jacket 50 of encapsulated conduit assembly 100. Said elongate V-shaped channel 51 is formed by converging sloped faces 52 defining channel base 53. Referring to FIG. 5, base 55 of outer jacket 50 of encapsulated conduit assembly 100 can have a substantially flat or planar configuration; however, it is to be observed that said base 55 can have a different shape or configuration without departing from the scope of the present invention.

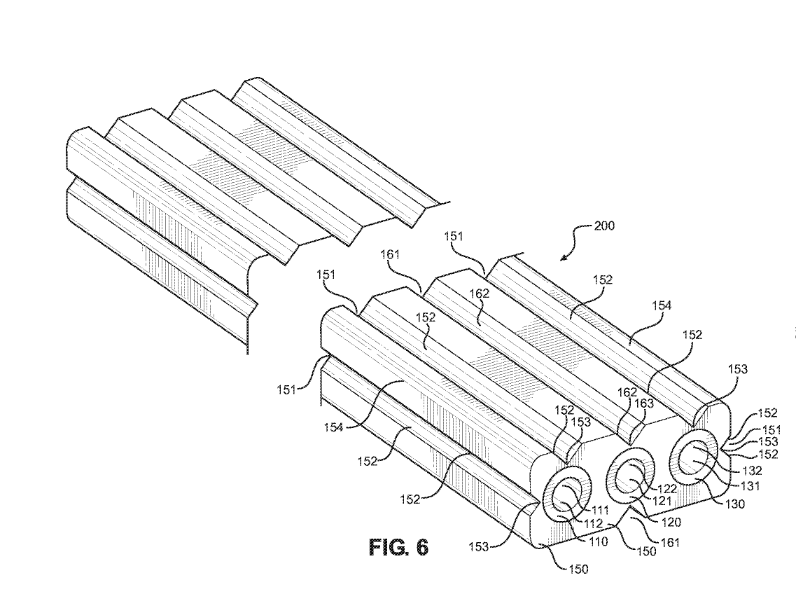

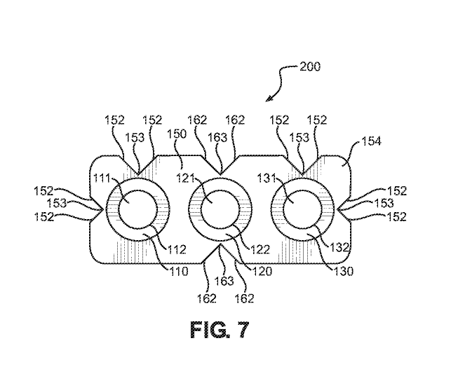

FIG. 6 depicts a perspective view of an alternative embodiment encapsulated conduit assembly 200 of the present invention, while FIG. 7 depicts an end view of said alternative embodiment encapsulated conduit assembly 200 of the present invention. As previously discussed, in certain circumstances, encapsulation material is used to combine multiple conduits in a single bundle—commonly referred to as a “flat-pack” or “flatpack”. Although said flatpacks can comprise internal components having numerous different diameters, configurations and materials, the embodiment depicted in FIGS. 6 and 7 comprise a plurality of elongate tubular conduits have substantially similar diameters and other dimensions.

Said encapsulated conduit assembly 200 comprises elongate tubular conduit 110 having central through bore 111 defining inner surface 112, elongate tubular conduit 120 having central through bore 121 defining inner surface 122, and elongate tubular conduit 130 having central through bore 131 defining inner surface 132. Protective outer coating or jacket 150 is generally disposed around the outer or external surfaces of said tubular conduits 110, 120 and 130. As depicted in FIGS. 6 and 7, tubular conduits 110, 120 and 130 are disposed in a substantially side-by-side configuration or in a single plane; however, it is to be observed that said conduits (which can number more or less than 3, as depicted for illustration purposes in FIGS. 6 and 7) can be arranged in any number of different patterns or relative orientations. Likewise, the dimensions of tubular conduits 110, 120 and 130 need not be identical and may be varied for different applications and/or operational environments.

In a preferred embodiment, said tubular conduits 110, 120 and 130 are encapsulated within protective outer jacket 150 comprising extruded thermoplastic polymer or other inert material. Said outer jacket 150 beneficially includes at least one engineered weakened section(s); that is, at least one strategically positioned region comprising reduced material mass. Said at least one engineered weakened section(s) can be created through an extrusion process, or through removal of extruded material in a secondary process.

Still referring to FIGS. 6 and 7, said outer jacket 150 comprises elongate grooves or channels 151 and 161. In a preferred embodiment, said elongate grooves or channels 151 and 161 are oriented substantially parallel to the longitudinal axes of said tubular conduits 110, 120 and 130, extending substantially along all or part of the length of encapsulated conduit assembly 200. Further, although the specific shape or configuration of said elongate channels 151 and 161 can vary without departing from the scope of the present invention, said elongate channels 151 and 161 are substantially V-shaped, being formed by converging sloped faces 152 and 162, respectively, defining channel bases 153 and 163. Said elongate channels 151 cooperate to define elongate protrusions 154 adjacent to tubular conduits 110 and 130.

In a preferred embodiment, said channel bases 153 beneficially do not extend fully to the outer surface of tubular conduits 110 and 130, while channel base 163 does not extend fully to conduit 120. As such, at least some portion of jacket material is disposed between said channel bases 153 and said outer surfaces of tubular conduits 110 and 130, and between channel base 163 and tubular conduit 120). As a result, said jacket material is at its weakest point between said channel bases 153 and outer surface of tubular conduits 110 and 130, and between said channel base 163 and outer surface of tubular conduits 120, and lacks the strength of other surrounding portions of protective jacket 150.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An encapsulated conduit assembly comprising:
a) at least one tubular conduit; and
b) a protective jacket encapsulating said conduit and defining a first thickness, wherein said protective jacket further comprises at least one section of reduced material defining a second thickness, and wherein said protective jacket has a lower tear strength at said second thickness than said first thickness.

2. The encapsulated conduit of claim 1, wherein said at least one tubular conduit contains hydraulic fluid.

3. The encapsulated conduit of claim 1, wherein said at least one tubular conduit contains at least one chemical.

4. The encapsulated conduit of claim 1, wherein said protective jacket comprises an extruded thermoplastic or thermoset polymer.

5. The encapsulated conduit of claim 1, wherein said at least one section of reduced material comprises a channel oriented substantially parallel to said longitudinal axis of said at least one conduit.

6. The encapsulated conduit of claim 5, wherein said channel is substantially V-shaped.

7. The encapsulated conduit of claim 1, wherein said protective jacket is configured to be removed from said at least one conduit without use of a knife, tool or other implement.

8. A method for removing a protective jacket from at least one conduit comprising:
a) providing an encapsulated conduit assembly comprising:
i) at least one tubular conduit;
ii) a protective jacket encapsulating said conduit and defining a first thickness, wherein said protective jacket further comprises at least one section of reduced material defining a second thickness, and wherein said protective jacket has a lower tear strength at said second thickness than said first thickness;
b) gripping a portion of said protective jacket;
c) applying force to a portion of said protective jacket; and
d) preferentially tearing said proactive jacket at said at least one area of reduced material.

9. The method of claim 8, further comprising removing a portion of said protective jacket from said at least one conduit.

10. The method of claim 8, wherein said at least one tubular conduit contains hydraulic fluid.

11. The method of claim 8, wherein said at least one tubular conduit contains at least one chemical.

12. The method of claim 8, wherein said protective jacket comprises an extruded thermoplastic or thermoset polymer.

13. The method of claim 8, wherein said at least one section of reduced material comprises a channel oriented substantially parallel to said longitudinal axis of said at least one conduit.

14. The method of claim 13, wherein said channel is substantially V-shaped.

15. The method of claim 8, wherein said protective jacket is configured to be removed from said at least one conduit without use of a knife, tool or other implement.
